(19) United States
(12) Patent Application Publication
(10) Pub. No.: US 2011/0199764 A1
(43) Pub. Date: Aug. 18, 2011

(54) DEVICE AND METHOD FOR CONTROLLING AN ANGULAR COVERAGE OF A LIGHT BEAM

(75) Inventor: Diana Shapirov, Yokneam Elit (IL)

(73) Assignee: CAMTEK lTD., MigdalHaemek (IL)

(21) Appl. No.: 12/064,363

(22) PCT Filed: Aug. 16, 2006
(86) PCT No.: PCT/IL06/00951

§ 371 Date: Jun. 30, 2008

Related U.S. Application Data
(60) Provisional application No. 60/711,428, filed on Aug. 26, 2005.

(51) Int. Cl. F21V 5/00; F21S 8/00

(52) U.S. Cl. 362/235; 362/277

(57) ABSTRACT

A system and method for controlling an angular coverage of a light beam. The method includes: defining a non-uniform angular coverage of a first light beam; altering a first spatial relationship between a first movable transmissive deflector and a first light source in response to the definition; directing a first light beam from the first light source through the first movable transmissive deflector such as to provide a first deflected light beam; and focusing the first deflected beam, by a first optical focusing element, to provide a first focused light bean that is focused onto a first area that is characterized by a location that is substantially indifferent to changes in the first spatial relationship.

### RELATED APPLICATIONS

This patent application claims priority from U.S. provisional application titled “Variable Angle Discontinues Illumination Device for Surface Inspection”, Ser. No. 60/711428, filed 26 Aug. 2005.

### FIELD OF THE INVENTION

The invention relates to systems and methods for controlling an angular coverage of a light beam, especially in optical inspection systems that inspect electrical circuits.

### BACKGROUND OF THE INVENTION

Optical inspection systems can detect defects in inspected objects (such as printed circuit boards, wafers, masks and reticles) by illuminating an inspected object and processing images generated in response to the illumination.

Optical inspection systems for Printed Circuit Boards have to discriminate between materials. For example, these systems have to discriminate between insulators and conductors that are made of different materials. Each combination of insulator and conductive materials requires specific illumination conditions in order to obtain best image contrast.

During the last decade PCB technology is characterized by an increase in line/space density. Fine line (high line/space density) PCB defect detection applications are specified by additional optical property: namely, a significant multiple inter-reflection between edges of adjacent conductors and the insulator spaces. This fact makes fine line application strongly depended on angular pattern of the applied illumination. High numerical aperture (more than 0.5) illumination makes lines thicker, and spaces thinner, thus, suppressing overall contrast to zero.

Fine defects, especially surface defects, are represented mostly by their three dimensional geometry. In order to be well distinguished from their surroundings, the defects should be illuminated in a very special manner with a strong shadowing effect.

A continuous uniform (“dome” or “quasi-lambertian”) illumination pattern illustrated in U.S. Pat. No. 4,877,326 of Chadwick and U.S. Pat. No. 5,058,982 of Katzir, being incorporated herein by reference, provides a uniform illumination coverage and reduce shadowing effect: thus, make all 3D surface irregularities undistinguishable. In order to enhance the local contrast between a defect and its surroundings it is necessary to create illumination pattern, which enhances shadowing effect. Such effects require discontinuities (or strong modulation) in the angular illumination pattern. The illumination angular discontinuities, briefly named “holes”, should be controlled to fit the various combinations of different defects and surface reflectance properties.

The optimal angular pattern of PCB illumination is a function of specific conductor/insulator materials, line/space physical dimension and type of defects to be detected.

In order to detect defects in different PCBs that are characterized by different materials and/or different geometrical relationships between conductors and insulators the automatic inspection system has to adjust the illumination pattern.

Various variable angle illumination systems are illustrated in the following U.S patents, all being incorporated herein by reference: U.S. Pat. No. 4,893,223 of Arnold, U.S. Pat. No. 5,185,638 of Conzola at al, U.S. Pat. No. 5,984,493 of Higgins at al., U.S. Pat. No. 6,788,411 of Lebens, U.S. Pat. No. 6469784 of Goldberg et al., U.S. Pat. No. 6,853,446 of Almogy et al.

There is a need to provide an efficient system and method for controlling an angular coverage of a light beam.

### SUMMARY OF THE INVENTION

A system and method for controlling an angular coverage of a light beam. The method includes: defining a non-uniform angular coverage of a first light beam; altering a first spatial relationship between a first movable transmissive deflector and a first light source in response to the definition; directing a first light beam from the first light source through the first movable transmissive deflector such as to provide a first deflected light beam; and focusing the first deflected beam, by a first optical focusing element, to provide a first focused light bean that is focused onto a first area that is characterized by a location that is substantially indifferent to changes in the first spatial relationship.

A system for controlling an angular coverage of a light beam. The system includes: a first light source, a first optical focusing element; and a first movable transmissive deflector adapted to deflect a first light beam originating from the first light source towards the first optical focusing element to provide a first deflected light beam; wherein the first optical focusing element focuses the first deflected light beam to provide a first focused light beam that is focused onto a first area that is characterized by a location that is substantially indifferent to changes in a first spatial relationship between the first movable transmissive deflector and the first optical focusing element; and wherein a non-uniform angular coverage of the first focused light beam is determined by the first spatial relationship.

### BRIEF DESCRIPTION OF THE DRAWINGS

The present invention will be understood and appreciated more fully from the following detailed description taken in conjunction with the drawings in which:

FIG. 1 illustrates a system, according to an embodiment of the invention;

FIG. 2 illustrates a system according to another embodiment of the invention;

FIG. 3 illustrates a system according to a further embodiment of the invention;

FIG. 4 illustrates a system according to yet another embodiment of the invention;

FIG. 5 illustrates exemplary relationship between a location of a first deflector module and a deflection angle of a deflected light beam;

FIG. 6 illustrates exemplary relationships between a location of a first deflector module and an incidence angle of a light beam according to an embodiment of the invention;

FIG. 7 illustrates exemplary relationship between a location of a second deflector module and a deflection angle of a deflected light beam;

FIGS. 8A-8E illustrate various coordinate systems and illustrate exemplary maximum angular intensity contour maps of the light beam according to an embodiment of the invention;

FIG. 9 is a flow chart illustrating a method according to an embodiment of the invention; and

FIG. 10 is a flow chart illustrating a method according to an embodiment of the invention

### DETAILED DESCRIPTION OF THE DRAWINGS

Various embodiments of the invention are herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

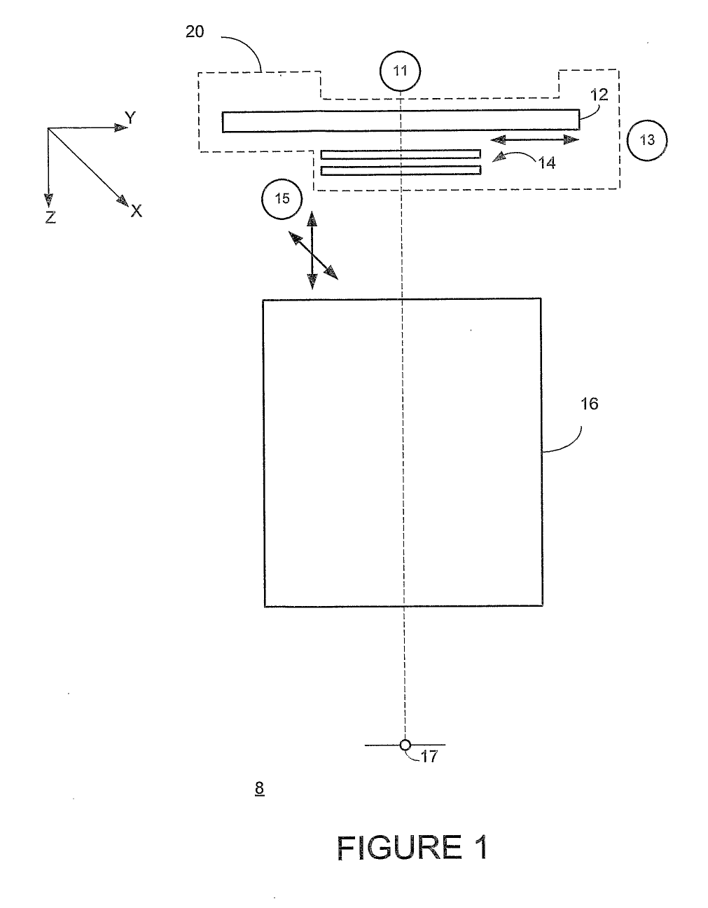

FIG. 1 illustrates system 8, according to an embodiment of the invention.

FIG. 1 also illustrates an imaginary coordinate system that includes an x-axis, a y-axis and a z-axis.

System 8 includes a first light source 11, optical focusing element 16 and a first movable transmissive deflector 20 that includes first deflector module 12 and second deflector module 14. The first deflector module 12 is moved along the y-axis by driver 13 while the second deflector module 14, and conveniently a portion of second deflector module 14 is movable, along the x-axis and the z-axis, by driver 15.

Conveniently, first deflector module 12 (also referred to as Y-direction light deflector) is a thin spatially varied micro-prism that is positioned very close to light source 11.

First optical focusing element 16 receives one of more deflected light beams from first movable transmissive deflector 20 and focuses the one or more deflected light beams to provide one or more focused light beams that are focused onto first area 17. First area 17 can be located on a surface of an inspected electrical circuit. Selected parts of the inspected electrical circuit (or even the whole inspected electrical circuit) can be illuminated by moving the inspected electrical circuit in relation to various components such as first light source 11, optical focusing element 16 and first movable transmissive deflector 20. This movement does not affect the spatial relationship between the first area 17 and the first light source 11.

In addition, the close proximity between first light source 11 and the first deflector module 12 reduces and even substantially eliminates changes in the location of first area 17 due to movements of first movable transmissive deflector 20 in relation to the first light source.

A first spatial relationship is defined between first light source 11 and first movable transmissive deflector 20. This spatial relationship can be altered by driver 13 and driver 15. As illustrated in the following figures, the location of the first movable transmission deflector 20 and especially of the first and second deflector modules 12 and 14 define the shape of the deflected light beam as well as the where the deflected light beam interacts with the first optical focusing element 16. These parameters define the deflection angle as well as the shape of the focused light beam.

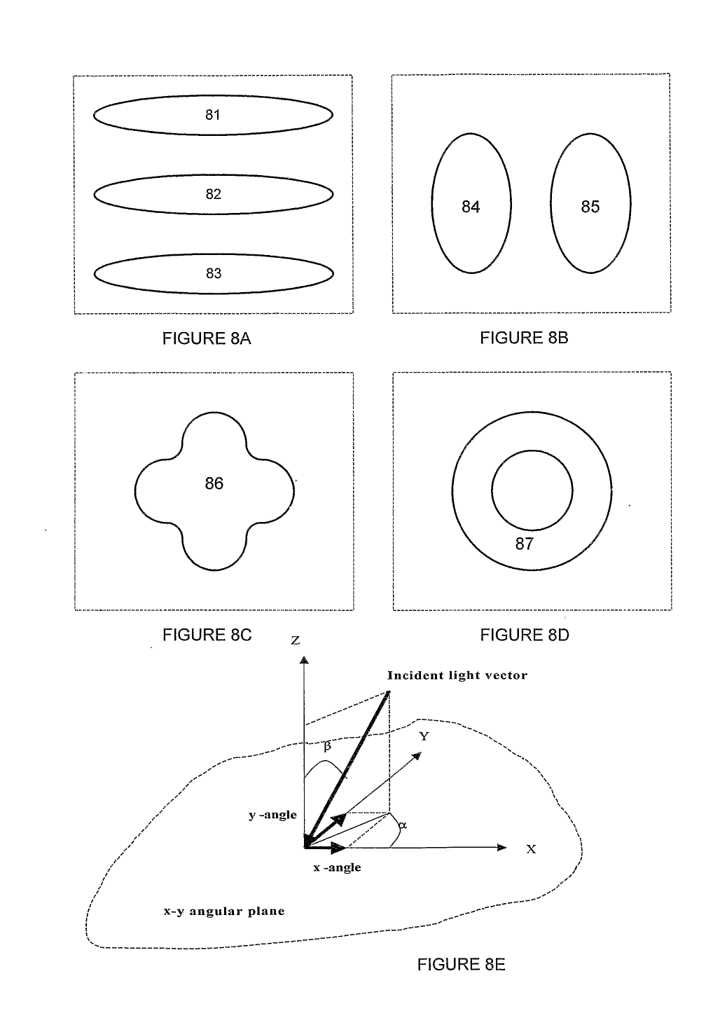

It is noted that the angular converge of a light beam includes the light beam orientation (three dimensional incidence angle) as well as the shape of the light beam. When multiple light sources, movable transmissive deflectors and optical focusing elements are used, they can be arranged to direct multiple light beams towards substantially the same area, thus providing complex illumination patterns, as illustrated in various examples provided in FIG. 8.

It is further noted that the possible range of incidence angles is determined by the numerical aperture of the movable transmissive elements, the numerical aperture of the first optical focusing element and the relative locations of these components.

The numerical aperture of the first light source 11 and of the first optical focusing element 16 is selected such as to provide a focused light beam that can be either relatively narrow or even wider, but does not is not provide a “dome” illumination.

The drivers 15 and 13 can easily and quickly move the first and second deflector modules 12 and 14, thus allowing to quickly alter the angular coverage of the light beam.

Accordingly, during a scanning of an electrical circuit the shape and angle of incidence of the focused light beam can be change. The drivers can be highly accurate linear motors.

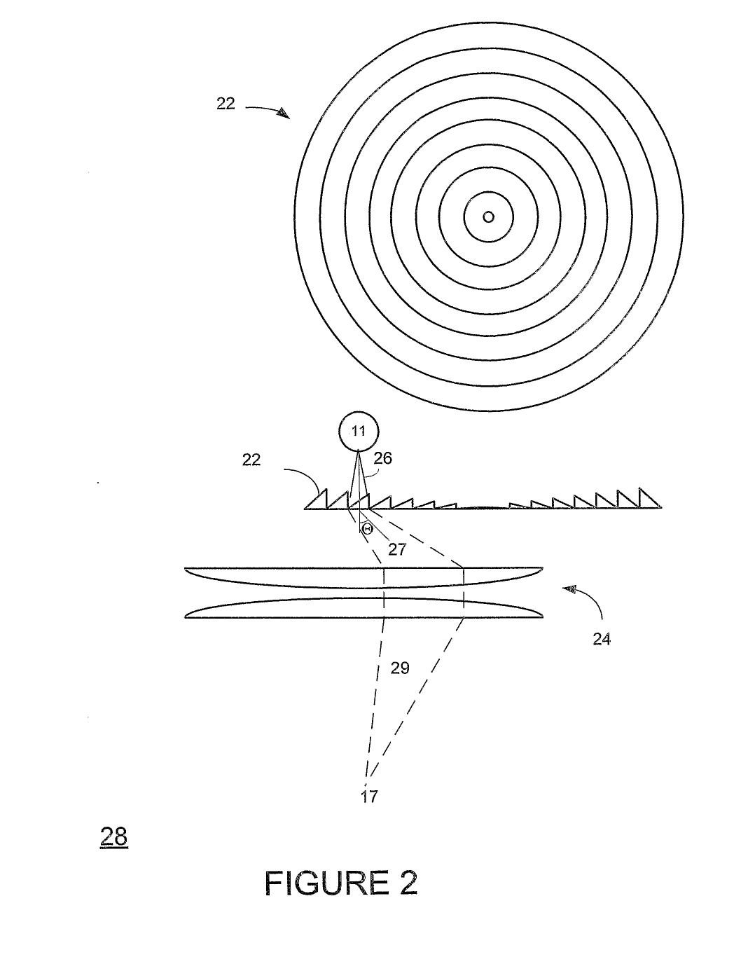

FIG. 2 illustrates system 28 according to another embodiment of the invention.

System 28 includes first light source 21 first movable transmissive deflector 22 and first optical focusing element 24.

First light source 21 is a point-like light source that can be a single Light Emitting Diode (LED), can be outputted from a fiber or can propagate through a pinhole.

First movable transmissive deflector 22 is a spatially varied lens such as Fresnel lens that is movable along the x-y plain.

A Fresnel lens includes stepped setbacks that can be charactarized by different optical charactaristics. A circular Fresnel lens can include multiple concentric annular grooves (also referred to as Fresnel zones), each charactarized by a different curvature or slope. A linear Fresnel lens includes a set of linear setbacks. Each Fresnel zone deflects light in a different deflection angle. Accordingly, by altering the relative location of Fresnel lens 22 in relation to first light source 21 the deflection angle of the deflected light beam changes.

For simplicity of explanation a driver that moves the first movable transmissive deflector 22 is not shown. First optical focusing element 24 includes two transparent parallel lenses.

A light beam 26 is generated by first light source 21 and is deflected by first movable transmissive deflector 22 to provide a deflected light beam (having a deflection angle 0) 27 that is then focused by first optical focusing element 24 to provide focused light beam 29.

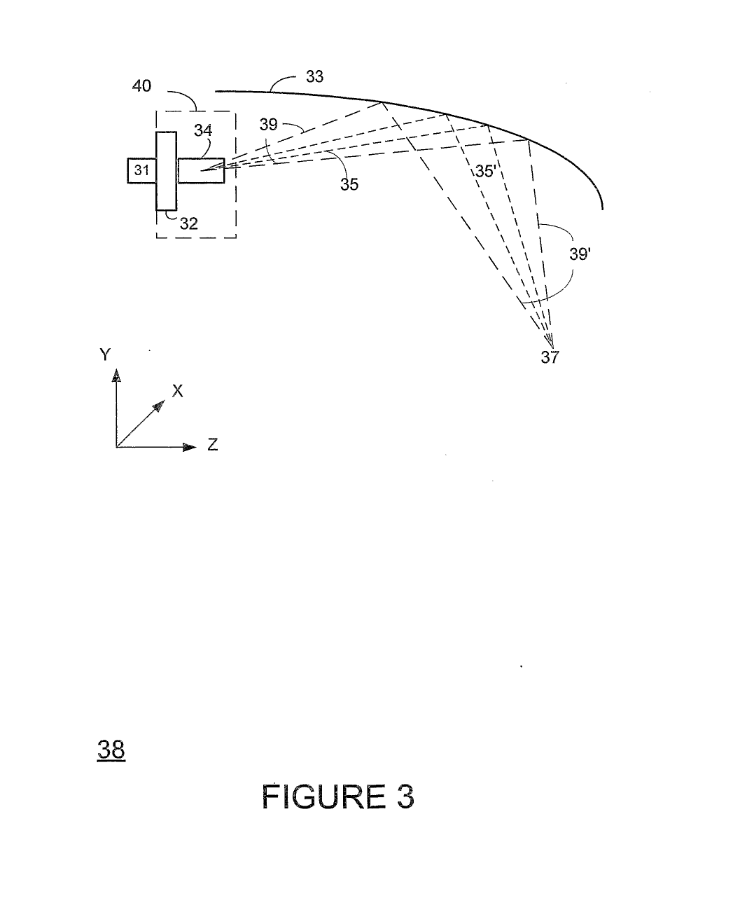

FIG. 3 illustrates system 38 according to a further embodiment of the invention.

System 38 includes first light source 31, first movable transmissive deflector 40 and first optical focusing element 33.

First light source 31 is a linear (line-like) light source. It can include a line of LEDS, a linear array of fibers, a light source that is followed by a linear slot, and the like.

First optical focusing element 33 is a cylindrical elliptical mirror having a first focal line in a position substantially coinciding with the location of the first light source 31 and a second focal line in a position coinciding with the location of first area 37.

First movable transmissive deflector 40 includes first movable transmissive deflector 32 (also referred to y-axis deflector module) and second deflector module 34 (also referred to as x-z axis deflector module).

FIG. 3 illustrates two deflected light beams 35 and 39 and two focused light beams 35′ and 39′ that correspond to the deflected light beams. Conveniently, focused light beam 35′ is generated when first movable transmissive deflector 40 is at a certain position and focused light beam 39′ is generated when first movable transmissive deflector 40 is at another position. the incidence angle of focused light beam 39′ is different from the incidence angle of 35′.

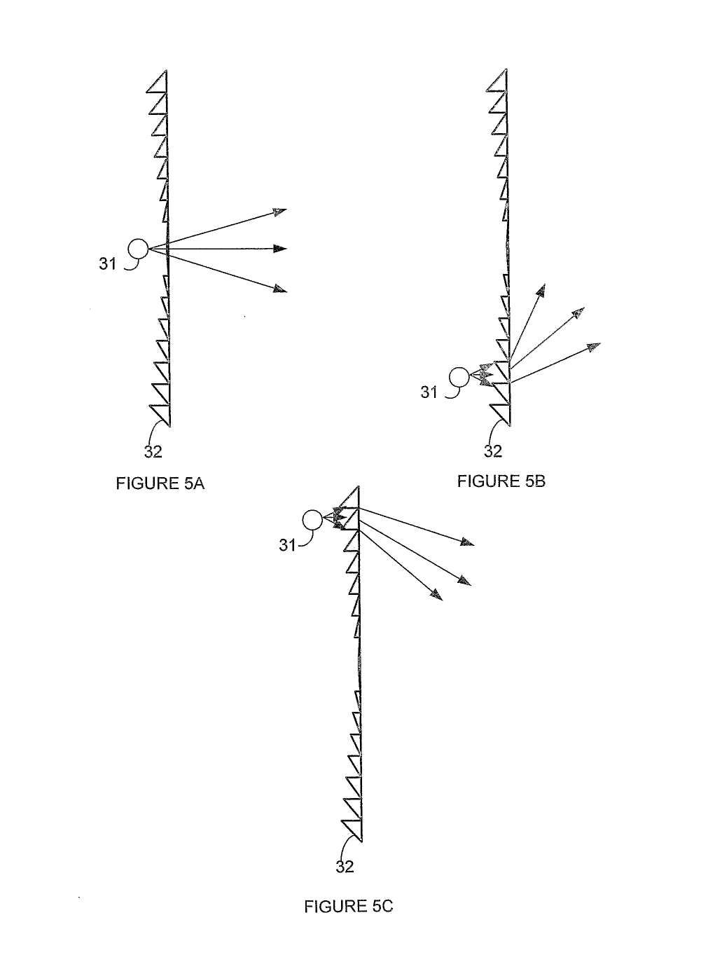

First deflector module 32 can be a Fresnel lens. The central part of a Fresnel lens allows light beam to pass through without bending (zero deflection angle, illustrated in FIG. 5A). The deflection angle increases as light beam propagates through Fresnel lens portion that are more distant from the central part of the Fresnel lens, as illustrated in FIGS. 5B and 5C). Moving Fresnel lens 32 up and down (along the y-axis) deflects light beams by various deflection angles. Conveniently, Fresnel lens 32 is very thin and positioned very close to first light source 31.

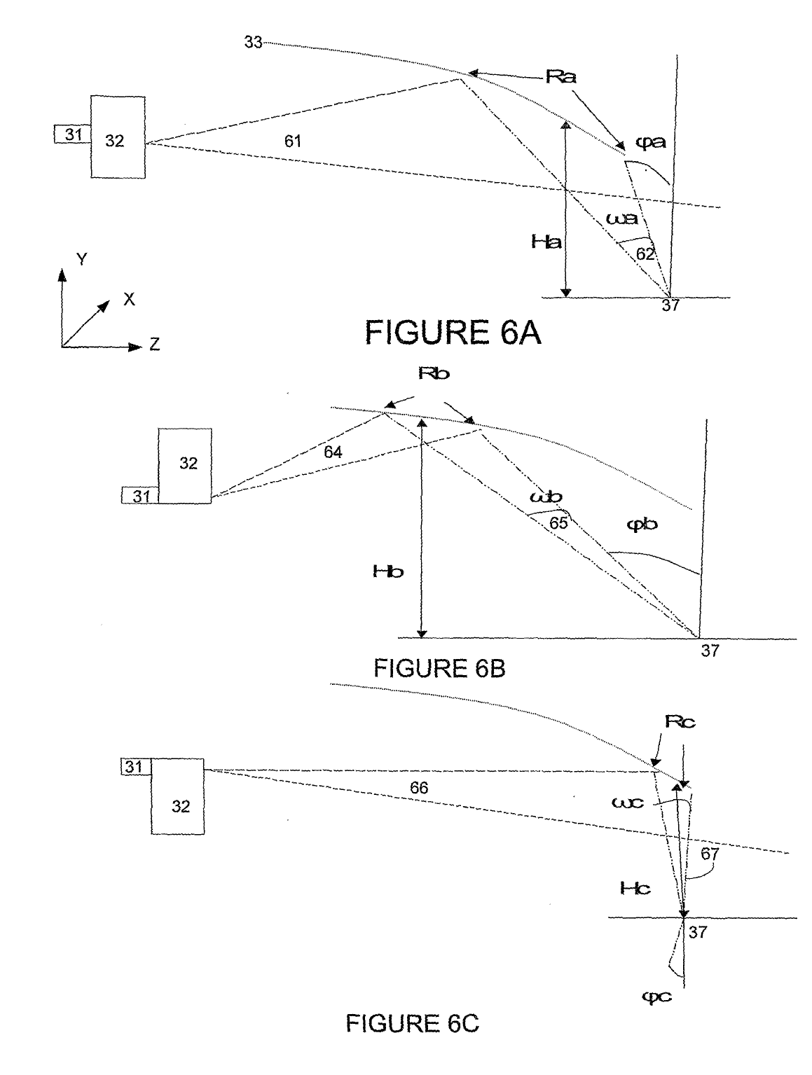

FIGS. 6A-6C illustrate the relationship between the location of the first deflector module 32 and the angular coverage of the focused light beam that illuminates first area 37. The angular coverage of the focused light beam is defined by two angles: angle of incidence φ and the angle width ω. For simplicity of explanation the second deflector module 34 was omitted from this figure.

FIG. 6A illustrates a scenario in which the light beam from first light source 31 passes through the central point of the Fresnel lens and is not deflected. A portion 61 of the emitted light beam is directed towards first optical focusing element 33 at arc sector Ra, and is eventually focused onto first area 37. Focused light beam 62 is characterized by a width ωa and an incidence angle of φa and a working distance Ha of the focusing element 33, which is related to a specific arc sector Ra.

FIG. 6B illustrates a scenario in which the light beam from first light source 31 passes through a lower point of Fresnel lens 32. A portion 64 of the emitted light beam is directed towards first optical focusing element 33 at a arc sector Rb, and is eventually focused onto first area 37. Focused light beam 65 is characterized by a width cob and an incidence angle of φb and a working distance Hb of the focusing element 33, which is related to a specific arc sector Rb.

FIG. 6C illustrates a scenario in which the light beam from first light source 31 passes through an upper point of Fresnel lens 32

A portion 66 of the emitted light beam is directed towards first optical focusing element 33 at arc sector Rc, and is eventually focused onto first area 37. Focused light beam 67 is characterized by a width ωc and an incidence angle of φc and a working distance Hc of the focusing element 33, which is related to a specific arc sector Rc.

FIGS. 6A-6C illustrate the geometrical relations between the arc sector on the focusing element 33 and working distances H, and the corresponding incidence and width angles: Ra>Rb>Rc and Ha>Hb>Hc and ωa>ωb>ωc and φa>φb>φc.

FIGS. 6A-6C demonstrate the angular control of the focused light beam by the optical combination of the deflecting element 32 and the focusing element 33.

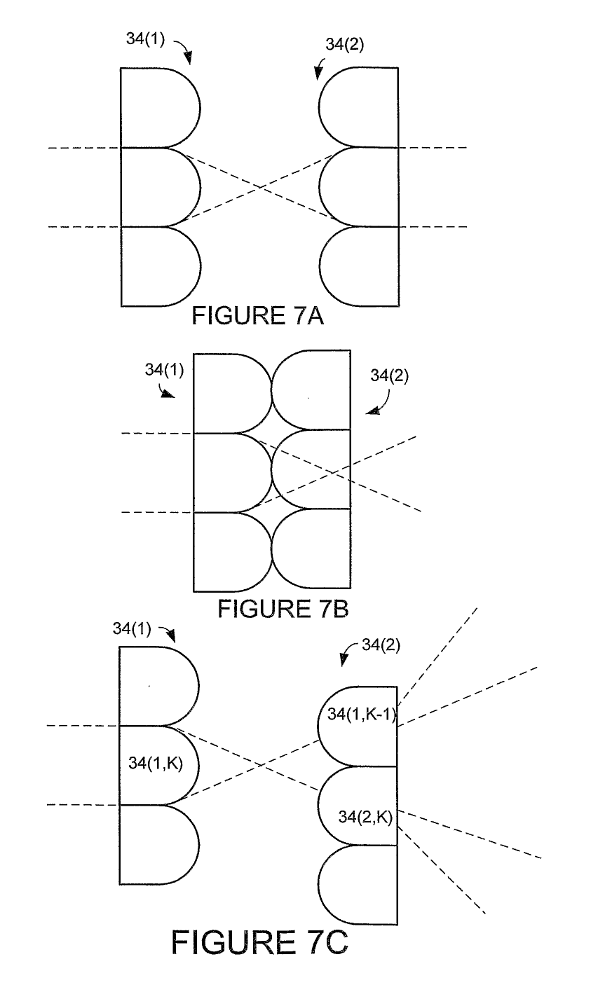

Referring back to FIG. 3, second deflector module 34 that includes a pair of cylindrical lenslet arrays 34(1) and 34(2). The relative location of one cylindrical lenslet array 34(1) in relation to the second cylindrical lenslet array 34(2) defines a deflection angle as well as a splitting angle of the light beam, as illustrated in FIGS. 7A-7C. For simplicity of explanation FIG. 7 does not include first deflector module 32, and the light beam directed towards the pair of cylindrical lenslet arrays is collimated.

FIG. 7A illustrates a scenario in which first and second cylindrical lenslet arrays 34(1) and 34(2) are parallel to each other (dx=0) and the distance between them equals the sum of the focal lengths (f34(1) and f34(2))of each pair of corresponding lenslets within first and second cylindrical lenslet arrays 34(1) and 34(2). In mathematical terms dz=f34(1)+f34(2)−dz should be added to the figure.

It this scenario a collimated beam of light that propagates orthogonally to first cylindrical lenslet array 34(1) passes through first and second cylindrical lenslet arrays 34(1) and 34(2) without being deflected.

FIG. 7B illustrates a scenario in which first and second cylindrical lenslet arrays 34(1) and 34(2) are parallel to each other (dx=0) but substantially touch each other (dx=0, dz=0). It this scenario a collimated beam of light that propagates orthogonally to first cylindrical lenslet array 34(1) is expanded by second cylindrical lenslet array 34(2).

FIG. 7C illustrates a scenario in which the distance (dz) between the first and second cylindrical lenslet arrays 34(1) and 34(2) equals the sum of the focal lengths of the first and second cylindrical lenslet arrays and dx>0. In this scenario a light beamlet that passes through lenslet 34(1,k) of first cylindrical lenslet array 34(1) propagates towards two lenslets 34(2,k−1) and 34(2,k) of second cylindrical lenslet array 34(2), causing a light beam that passes through lenslet 34(1,k) to be split to two deflected light beams.

It is noted that different deflection patterns can be generated by placing second cylindrical lenslet array 34(2) at different dx and dz displacements in relation to first cylindrical lenslet array 34(1).

It is noted that the inventors used a static first cylindrical lenslet array 34(1) and a movable second cylindrical lenslet array 34(2) but this is not necessarily so.

First cylindrical lenslet array 34(1) was positioned very closely to first light source 31. The second cylindrical lenslet array 34(2) was movable along z-axis and x-axis independently.

The translations, dx and dz, determine the deflection pattern (for example, width and splitting manner) of one or more deflected light beam. The deflection provides discontinuities of the focused light beam angular coverage. It is noted that if the light source provides a quasi- collimated light beam wider manipulation of the deflected light bean can be provided.

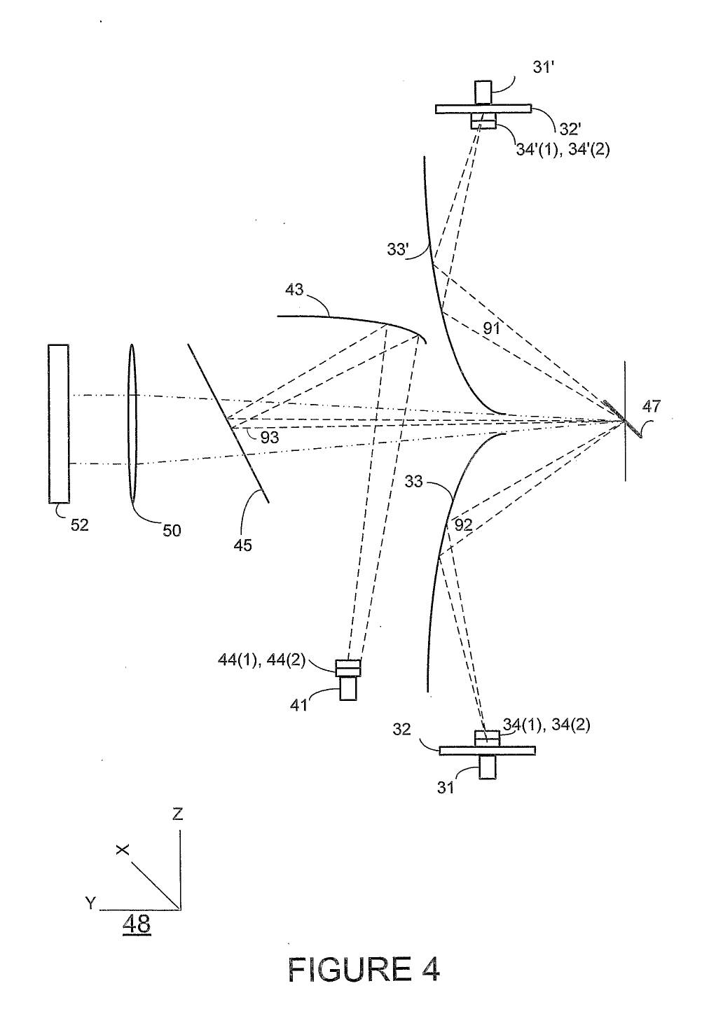

FIG. 4 illustrates system 48 according to yet another embodiment of the invention.

System 48 includes two dark field illumination paths and a single bright field illumination path. The first area 47 is illuminated by three light beams 61,62,63 and their intensities are added to each other (by superposition).

A single collection path is shared by the different illumination paths. It is noted that the number of paths and their types can be altered without departing from the scope of the invention.

First dark field illumination path includes a linear light source such as first light source 31, first optical focusing element such as first elliptical cylindrical mirror 33 and a first movable transmissive deflector that includes first deflector module 32 and a second deflector module 34 that in turn includes a first pair of cylindrical lenslet arrays 34(1) and 34(2). The first dark field illumination path directs a first focused light beam onto a first linear area 47.

Second dark field illumination path includes a linear light source such as second light source 31′, second optical focusing element such as second elliptical cylindrical mirror 33′ and a second movable transmissive deflector that includes third deflector module 32′ and fourth deflector module 34′ that in turn includes a pair of cylindrical lenslet arrays 34′(1) and 34′(2). The second dark field illumination path directs a second focused light beam onto a second linear area that can be positioned near first liner area. FIG. 4 illustrates a second linear area that overlaps first linear area 47.

The first and second dark field paths are positioned in symmetrical (although these paths can be positioned in an asymmetrical) relationship to first linear area 47 whereas the first and second elliptical cylindrical mirrors 33 and 33′ are parallel to each other and are slightly distant from each other such as to define a gap through which a third (bright field) focused light beam as well as a deflected and reflected light beam can pass.

Bright field illumination path includes a linear light source such as third light source 41, third optical focusing element such as third elliptical cylindrical mirror 43 beam splitter 45 and a third movable transmissive deflector that includes fifth deflector module 44. The first deflection module 44 includes a pair of cylindrical lenslet arrays 44(1) and 44(2). Third linear light beam from third light source 41 is selectively spread or split by fifth deflector module 44. The one or more (if split) third deflected light beam propagates towards third elliptical cylindrical mirror 43 and is then focused onto beam splitter 45. Beam splitter 45 directs the third focused light beam towards a third area that can overlap first area 47. By altering the positions of first till fifth deflection modules a wide range of non-uniform angular coverage can be achieved.

Light scattered from first linear area 47 (in response to the first and second focused light beam) and reflected from first linear area 47 (in response to the third focused light beam) that are substantially orthogonal to the first linear area 47 propagate through the gap between cylindrical elliptical mirrors 33 and 33′, through beam splitter 45 and are detected by detector 52 positioned downstream of imaging lens 50 that images first linear area onto detector 52.

The inventors used first and second elliptical cylindrical mirrors 33 and 33′ having a long axis of 34.5 mm and short axis of 17 mm, and third elliptical cylindrical mirror 43 having a radius of 110 mm. First and third deflector modules 31 and 31′ are Fresnel lenses having a focal length of 12.7 mm and a clear aperture of 12 mm. They are shifted along the y-axis within a range of +5.5 mm, the step resolution is 0.1 mm and the thickness of the Fresnel lenses is 1.5 mm. The second and fourth deflector modules include pair of lenslet arrays, wherein the lenslet curvature radius is 2.5 mm and its thickness is 2 mm.

Those of skill in the art will appreciate that these numbers are provided for illustration only.

FIG. 8E illustrates the relationships between an azimuth angle α and zenith angle β of an incident light beam and between their projection on a Cartesian coordinate system that includes an X-axis, a Y-axis and Z-axis. An incident light vector is represented in the Cartesian coordinate system by its projections X_angle and Y_angle. In mathematical terms: X_angle=sinβ*sinα, and Y_angle=sinβcosα

FIGS. 8A-8D illustrate exemplary maximum angular intensity contour maps of the incident light beam vectors at imaginary x-y angular plane of the mentioned above Cartesian coordinate system, according to an embodiment of the invention

These maximum angular intensity contour maps were generated using a system such as system 48 of FIG. 4. It is noted that although FIGS. 6A-6C illustrates various spatial relationships between first light source 31 and Fresnel lens 32 then these spatial relationships can be maintained between second light source 31 and Fresnel lens 32′. It is further noted that although FIGS. 7A-7C illustrates the spatial relationships between lenslet arrays 34(1) and 34(2) then the same spatial relationships can be maintained between lenslet arrays 34′(1) and 34′(2) as well as between lenslet arrays 44(1) and 44(2).

FIG. 8A illustrates three horizontal narrow and long elliptical light spots 81-83 that are parallel to each other and slightly distant from each other. This maximum angular intensity contour map is achieved by using three linear light sources having numerical apertures that range between 0.15 and 0.2, by lifting (along the y-axis) first and third deflector modules 32 and 32′ (such as to be positioned in a position that is illustrated in FIG. 6B) and providing zero x-axis and zero z-axis (dz=0, dx=0) displacement between cylindrical lenslet arrays 34(1) and 34(2), between cylindrical lenslet arrays 34′(1) and 34′(2) and between cylindrical lenslet arrays 44(1) and 44(2).

FIG. 8B illustrates two horizontal elliptical light spots 84 and 85 that are wider and shorter than light spots 81-83 of FIG. 8A. Light spots 84 and 85 are parallel to each other and slightly distant from each other. This maximum angular intensity contour map is achieved by using three linear light sources having numerical apertures that range between 0.3 and 0.35, by slightly lifting (along the y-axis) first and third deflector modules 32 and 32′ (such as to be positioned in a position that is illustrated in FIG. 6A) and providing non-zero x-axis and non-zero z-axis (dz and dx differ from zero) displacements between cylindrical lenslet arrays 34(1) and 34(2), between cylindrical lenslet arrays 34′(1) and 34′(2) and between cylindrical lenslet arrays 44(1) and 44(2). The relative position of these lenslet arrays is illustrated in FIG. 7C.

FIG. 8C illustrates a cross shaped light spot 86. This maximum angular intensity contour map is achieved by using three linear light sources having numerical apertures that range between 0.15 and 0.2, by slightly lifting (along the y-axis) first and third deflector modules 32 and 32′ (such as to be positioned in a position that is illustrated in FIG. 6A) and providing zero x-axis displacement and non-zero z-axis displacement that equals sum of the focal length of a pair of lenslet arrays (dx=0,dz=F34(1)+F34(2)) between cylindrical lenslet arrays 34(1) and 34(2) and between cylindrical lenslet arrays 34′(1) and 34′(2). The relative position of these lenslet arrays is illustrated in FIG. 7A. Zero x-axis displacement and zero z-axis displacement are provided between cylindrical lenslet arrays 44(1) and 44(2).

FIG. 8D illustrates an annular shaped light spot 87. This maximum angular intensity contour map is achieved by using three linear light sources having numerical apertures that range between 0.3 and 0.35, by slightly lifting (along the y-axis) first and third deflector modules 32 and 32′ (such as to be positioned in a position that is illustrated in FIG. 6A), providing zero x-axis displacement and zero z-axis displacement (dx=0, dz=0) between cylindrical lenslet arrays 34(1) and 34(2) and between cylindrical lenslet arrays 34′(1) and 34′(2). The relative position of these lenslet arrays is illustrated in FIG. 7A. Zero x-axis displacement and zero z-axis displacement are provided between cylindrical lenslet arrays 44(1) and 44(2). Non-zero x-axis and non-zero z-axis (dz and dx differ from zero) displacements are provided between cylindrical lenslet arrays 44(1) and 44(2). The relative position of cylindrical lenslet arrays 44(1) and 44(2) is illustrated in FIG. 7C.

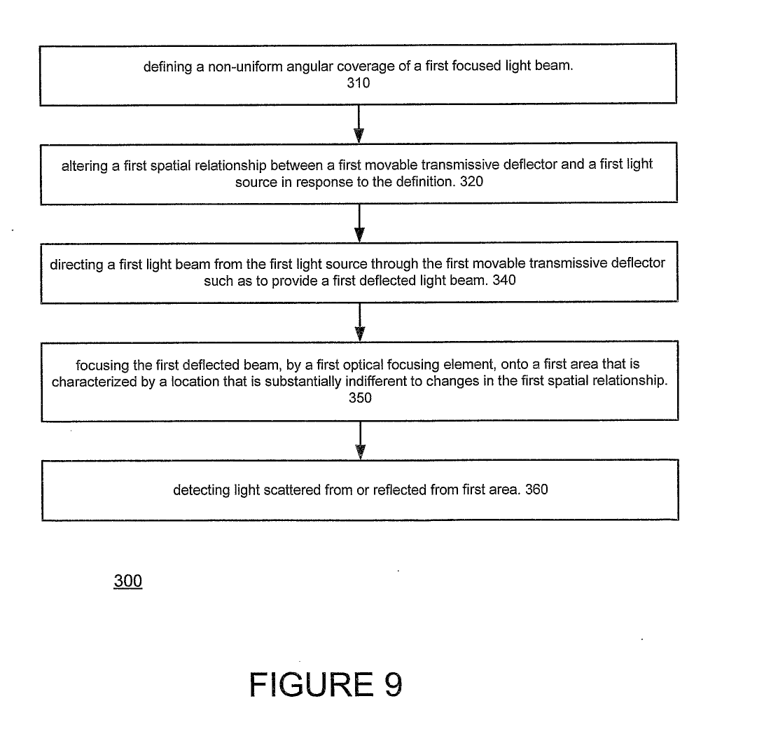

FIG. 9 is a flow chart illustrating method 300 according to an embodiment of the invention.

Method 300 starts by stage 310 of defining a non-uniform angular coverage of a first focused light beam.

The definition can be responsive to an expected structure of an inspected object that is scanned by the first focused light beam, to expected defects, to previously detected defects and the like.

Stage 310 is followed by stage 320 of altering a first spatial relationship between a first movable transmissive deflector and a first light source in response to the definition.

Stage 320 can be executed very quickly. If an object such as an electrical circuit is scanned the spatial relationship can be altered during the scanning of that object.

Conveniently, stage 320 includes at least one of the following: (i) moving a spatially varied micro-prism array such as a Fresnel lens along at least one axis, (ii) moving a first defector module and a second deflector module, (iii) moving a Fresnel lens, or (iv) moving a first micro-lens array out of a pair of micro-lens arrays that are included within the first movable transmissive deflector.

Conveniently, the moving of the first deflector module affects a first axis cross section of the angular coverage of the light beam and wherein the moving of the first deflector module affects a second axis cross section of the angular coverage of the light beam.

Stage 320 is followed by stage 340 of directing a first light beam from the first light source through the first movable transmissive deflector such as to provide a first deflected light beam.

Stage 340 is followed by stage 350 of focusing the first deflected beam, by a first optical focusing element, onto a first area that is characterized by a location that is substantially indifferent to changes in the first spatial relationship between.

Conveniently, stage 350 includes focusing the first deflected light beam onto a first focal line by an elliptical cylindrical mirror.

Stage 350 is followed by stage 360 of detecting light scattered from or reflected from first area. The detection angle is determined by the optical characteristics (numerical aperture, position in relation to the illumination path) of the collection path.

Conveniently, stage 340 includes converting the first light beam to multiple deflected light beams; and stage 350 includes focusing comprises focusing the multiple first deflected light beam onto the first area.

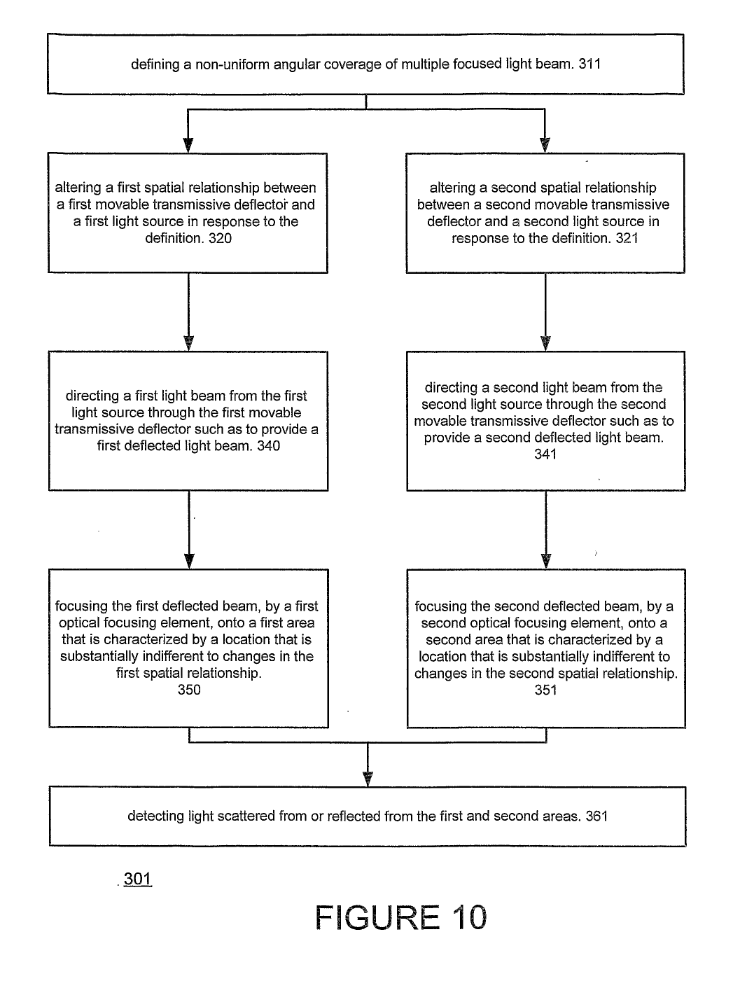

FIG. 10 is a flow chart illustrating method 301 according to another embodiment of the invention.

Method 301 differs from method 300 by including additional stages 321, 341 and 351 and by including stages 311 and 361 instead of stages 310 and 360.

Stage 311 includes defining a non-uniform angular coverage of multiple focused light beams.

Stage 321 includes altering a second spatial relationship between a second movable transmissive deflector and a second light source in response to the definition.

Stage 341 includes directing a second light beam from the second light source through the second movable transmissive deflector such as to provide a second deflected light beam.

Stage 341 is followed by stage 351 of focusing the second deflected beam, by a second optical focusing element, onto a second area that is characterized by a location that is substantially indifferent to changes in the second spatial relationship between. The second area can at least partially overlap the first area.

Stage 351 is followed by stage 361 of detecting light scattered from or reflected from the first and second areas. The detection angle is determined by the optical characteristics (numerical aperture, position in relation to the illumination path) of the collection path.

Although the invention has been described in conjunction with specific embodiments thereof, it is evident that many alternatives, modifications and variations will be apparent to those skilled in the art, accordingly, it is intended to embrace all such alternatives, modifications and variations that fall within the spirit and broad scope of the appended claims.

What is claimed is:

1. A system for controlling an angular coverage of a light beam, the system comprises:
a first light source,
a first optical focusing element; and
a first movable transmissive deflector adapted to deflect a first light beam originating from the first light source towards the first optical focusing element to provide a first deflected light beam;
wherein the first optical focusing element focuses the first deflected light beam to provide a first focused light beam that is focused onto a first area that is characterized by a location that is substantially indifferent to changes in a first spatial relationship between the first movable transmissive deflector and the first optical focusing element; and
wherein a non-uniform angular coverage of the first focused light beam is determined by the first spatial relationship.

2. The system according to claim 1 wherein the first movable transmissive deflector is a spatially varied micro-prism array movable along at least one axis.

3. The system according to claim 1 wherein the first movable transmissive deflector comprises a first deflector module and a second deflector module.

4. The system according to claim 3 wherein the first deflector module is adapted to move along a first axis while the second deflector module is adapted to move along a second axis traverse to the first axis.

5. The system according to claim 3 wherein the first deflector module is adapted to determine a first axis cross section of the angular coverage of the light beam while the second deflector module is adapted to determine a second axis cross section of the angular coverage of the light beam.

6. The system according to claim 2 wherein the spatially varied prism array is a Fresnel lens.

7. The system according to claim 3 wherein the second deflector module comprises two micro-lens arrays movable in relation to each other.

8. The system according to claim 1 further comprising a detector adapted to receive light reflected or scattered from the first area.

9. The system according to claim 1 wherein the first optical focusing element is an elliptical cylindrical mirror that focuses the deflected light beam onto a first focal line.

10. The system according to claim 1 wherein the first movable transmissive deflector is adapted to convert the first light beam to multiple deflected light beams; wherein the first optical focusing element focuses the multiple first deflected light beam onto the first area.

11. The system according to claim 1 wherein the system further comprises a controller adapted to control a fast alteration of the angular coverage of the light beam.

12. The system according to claim 1 wherein the first movable transmissive deflector is thin and positioned in close proximity to the first light source.

13. The system according to claim 1 further comprising: a second light source, a second optical focusing element; and a second movable transmissive deflector adapted to deflect a second light beam originating from the second light source towards the second optical focusing element to provide a second deflected light beam; wherein the second optical focusing element focuses the second deflected light beam to provide a second focused light beam that is focused onto a second area that is characterized by a location that is substantially indifferent to changes in a second spatial relationship between the second movable transmissive deflector and the second optical focusing element; and wherein a non-uniform angular coverage of the second focused light beam is determined by the second spatial relationship.

14. The system according to claim 12 wherein the first light source, first optical focusing element and the first movable transmissive deflector define a dark field illumination path and wherein the second light source, the second optical focusing element and the movable transmissive deflector define a bright field illumination path.

15. The system according to claim 1 further adapted to determine a location of the first movable transmissive deflector in response to expected defects of an object.

16. The system according to claim 1 further adapted to determine a location of the first movable transmissive deflector in response to previously detected defects of an object.

17. The system according to claim 1 wherein the first movable transmissive deflector is a spatially varied micro-prism array movable along two axes.

18. The system according to claim 17 wherein the first movable transmissive deflector is a circular Fresnel lens that comprises multiple concentric annular grooves.

19. The system according to claim 17 wherein the first optical focusing element comprises at least one transparent lens.

20. The system according to claim 17 wherein the first light source is a point like light source.

21. A method for controlling an angular coverage of a light beam, the method comprising:
defining a non-uniform angular coverage of a first light beam;
altering a first spatial relationship between a first movable transmissive deflector and a first light source in response to the definition;
directing a first light beam from the first light source through the first movable transmissive deflector such as to provide a first deflected light beam; and
focusing the first deflected beam, by a first optical focusing element, to provide a first focused light bean that is focused onto a first area that is characterized by a location that is substantially indifferent to changes in the first spatial relationship.

22. The method according to claim 21 wherein the altering comprises moving a spatially varied micro-prism array along at least one axis.

23. The method according to claim 21 wherein the altering comprises moving a first deflector module and a second deflector module.

24. The method according to claim 23 wherein moving of the first deflector module affects a first axis cross section of the angular coverage of the light beam and wherein the moving of the first deflector module affects a second axis cross section of the angular coverage of the second focused light beam.

25. The method according to claim 21 wherein the altering comprises moving a spatially varied micro prism array.

26. The method according to claim 21 wherein the altering comprises moving a first micro-lens array out of a pair of micro-lens arrays that are included within the first movable transmissive deflector.

27. The method according to claim 21 further comprising detecting light scattered or reflected from the first area.

28. The method according to claim 21 wherein the focusing comprises focusing the first deflected light beam onto a first focal line by an elliptical cylindrical mirror.

29. The method according to claim 21 wherein the directing comprises converting the first light beam to multiple deflected light beams; and wherein the focusing comprises focusing the multiple first deflected light beam onto the first area.

30. The method according to claim 21 wherein the altering comprises quickly altering the first spatial relationship.

31. The method according to claim 21 further comprising: defining a non-uniform angular coverage of a second light beam; altering a second spatial relationship between the a second movable transmissive deflector and a second light source in response to the definition; directing a second light beam from the second light source through the second movable transmissive deflector such as to provide a second deflected light beam; and focusing the second deflected beam, by a second optical focusing element, to provide a second focused light beam that is focused onto a second area that is characterized by a location that is substantially indifferent to changes in the second spatial relationship.

32. The method according to claim 31 further comprising detecting reflected light from the second area and detecting scattered light from the first area.

33. The method according to claim 21 wherein the defining is responsive to at least one characteristic of an expected defect of an object.

34. The method according to claim 21 wherein the defining is responsive to at least one characteristic of previously detected defects of an object.

35. The method according to claim 21 further comprising scanning an inspecting object.
